(19) United States
(12) Patent Application Publication
(10) Pub. No.: US 2010/0255693 A1
(43) Pub. Date: Oct. 7, 2010

(54) System and apparatus for mounting on modules

(76) Inventors: Bobby E. Brown, Garland, TX (US); Steven D. Sensel, Blue Ridge, TX (US)

Correspondence Address: Docket Administrator;Room 2F-192, Alcatel-Lucent USA Inc., 600 Mountain Avenue, Murry Hill, NJ, 07974-0636, US

(21) Appl. No.: 12/384,640

(22) Filed: Apr. 7, 2009

(51) Int. Cl. H01R 12/00

(52) U.S. Cl. 439/78

(57) ABSTRACT

An exemplary system comprises a cage, a carrier board and a motherboard. The cage is mounted to the carrier board. The carrier board is connected to and oriented approximately normal to the motherboard. The carrier board may include at least one first conductor disposed on a surface of the carrier board and the motherboard may includes a socket for receiving the at least one first conductor of the carrier board. A small form factor pluggable may be connected in the cage and thereby coupled to the motherboard, thus permitting orientation of optical SFP modules normal to the motherboard allowing increasing module density in the limited space available on shelf in a rack.

### FIELD OF THE INVENTION

The invention relates to mounting components on a circuit board of a module, and, in particular, to systems, apparatuses and techniques for such mounting.

### BACKGROUND INFORMATION

Networking equipment modules such as a switch, router, media converter, blade server, add/drop multiplexer, etc., or similar device are typically designed to be installed in a rack system. In a rack system, a plurality of network equipment modules is arrayed on a rack, each of the modules occupying a predetermined space on a shelf of the rack. The shelves in a rack typically lie in a horizontal plane, with the width of a shelf greater than the distance between adjacent shelves. For example, a standard equipment rack is 19 inches wide at the front with a number of rack units being allocated for each shelf depending on the dimensions of the module, a rack unit (i.e., measure of vertical space in an equipment rack) being is 1.75 inches.

The implementation of a network equipment module typically includes a motherboard (i.e., main circuit board), such that when the module is installed, the motherboard is disposed parallel to the shelf. Prior to installation, after fabrication of the motherboard is completed, electronic components must be connected to form a functional circuit assembly for the network equipment module. In through-hole construction, component leads are inserted in holes. In surface construction, the components are placed on pads or lands on the outer surfaces of the circuit board. In both kinds of construction, component leads are electrically and mechanically fixed to the board with a molten metal solder.

In other networking equipment embodiments, connectors are utilized to couple components to the motherboard. Each module includes a motherboard to which connectors are directly mounted. The connectors are mechanically fixed to the motherboard and ports are provided into which components may be releasably connected and thereby coupled to the motherboard. When positioned on a rack shelf, the motherboard of the module is disposed horizontal to the shelf and the connectors on the motherboard are accessed via a faceplate for connection of the components. The use of connectors for the mounting of components, rather than direct soldering, increases the flexibility and versatility of such network systems, making them easier and less expensive to maintain.

The connectors may be small form factor (SFF) connectors, which refers to any of several physically compact connector designs that have been developed for use in fiber optic systems. The size of SFF connectors is reduced as compared to conventionally sized connectors. Using SFF connectors, it is possible to get a greater number of components interfaced to a single module. A component such as a small form-factor pluggable (SFP) may be connected via the SFF connector. A SFP is a compact, hot-pluggable device (e.g., transceiver) used for both telecommunications and data communications applications. A SFP interfaces a network device motherboard (e.g., for networking equipment such as a switch, router, media converter, blade server, add/drop multiplexer, etc., or similar device) to a fiber optic or copper networking cable. The SFP plugs into a corresponding SFP cage/connector to connect to the network device motherboard.

SFP transceivers may be designed to support, for example, SONET, Gigabit Ethernet, Fibre Channel, and other communications standards, including SFP+ and thus are able to support various data rates. SFP transceivers also are available with a variety of different transmitter and receiver types, allowing users to select the appropriate transceiver for each network link to provide the required optical reach over the available optical fiber type (e.g. multi-mode fiber or single-mode fiber).

Because SFPs can be easily interchanged, electro-optical or fiber optic networks can be upgraded and maintained more conveniently than with traditional soldered-in components. Rather than replacing an entire circuit board containing several soldered-in components, a single SFP can be removed and replaced for repair or upgrading, resulting in substantial cost savings, both in maintenance and in upgrading efforts. However, the number of connectors readily accessible at a faceplate on the exterior of a module for connection of components is limited by the connector and the area of the motherboard upon which connectors may be directly mounted adjacent and accessible to the faceplate.

### SUMMARY OF THE INFORMATION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to a more detailed description.

Provided are systems, apparatus and techniques for mounting of connectors and associated components, such as small form factor pluggable (SFPs), in a networking device. The provided embodiments orient the connection of components at a substantially right angle to the motherboard so as to permit the arrangement into the same area of a greater number of components at a decreased pitch. As a result, embodiments of network equipment modules according to the invention enable increased bandwidth to be provided. Further module embodiments may advantageously include features such as manufacturing assistance features for assembly placement and interfacing (e.g., a card cage design approach) and heat management features.

An exemplary system in accord with the invention includes a cage, a carrier board and a motherboard. The cage is mounted to the carrier board. The carrier board is connected to and oriented approximately normal to the motherboard. The carrier board may include at least one first conductor disposed on a surface of the carrier board with the motherboard including a corresponding socket for receiving the at least one first conductor. With such a system, a higher density of cages may be positioned along an edge of the motherboard as compared to direct mounting of cages to a motherboard.

In one embodiment, the system further includes a front panel including a carrier guide. While the front panel prevents movement of the carrier board perpendicular to the motherboard in the system, the carrier guide receives an edge of the carrier board and prevents movement of the carrier board in a plane parallel to the motherboard. The front panel may be made of a thermal conductive material. The front panel may also be mounted to an anchor point on the motherboard to assist in thermal management, such as removing heat by conduction and convection. The system may also include an ejector connected to the front panel.

In an embodiment, the carrier board has a first side and includes a lateral extension on a first portion of the first side; the first conductor is disposed on the lateral extension. In one embodiment, the motherboard includes a cutout, with portions of the cage lying in the cutout. In another, portions of the carrier board lie in the cutout.

In one embodiment, a small form factor pluggable may be connected in the cage. The SFP is thus oriented normal to the mother board, which permits increased SFP density in the limited accessible space available on module positioned in a rack. The small form factor pluggable may be an optical small form factor pluggable. The small form factor pluggable may be one of a transceiver, receiver or transmitter.

One system embodiment comprises a small form factor cage, a carrier board and a motherboard. The small form factor cage is mounted to the carrier board, a connector port being defined by the small form factor cage and the carrier board, the interior of the connector port including a first connection point for a first conductor, the first conductor running to a second connection point located outside the connector port but on the carrier board. The carrier board is oriented normal to a motherboard, which includes a socket for receiving the second connection point.

In one embodiment, the carrier board has a first edge and includes a lateral extension on a first portion of the first edge, with the second connection point located on a surface of the lateral extension. In another embodiment, the motherboard includes a cutout proximate the socket, with portions of the small form factor cage and the carrier board lying in the cutout.

In an embodiment, the motherboard includes an anchor point. The system may further include a thermal conductive front panel including a carrier guide for receiving the carrier board wherein the front panel is connected to motherboard at the anchor point, thereby minimizing movement of the carrier board relative to the motherboard. A module ejector may be connected to the front panel.

In a further embodiment, an optical small form factor pluggable is connected to the small form factor cage. The small form factor pluggable may be a transceiver, receiver or transmitter.

An exemplary networking equipment comprises a first circuit board including a socket mounted thereon; a second circuit board oriented normal to a first circuit board, wherein a first conductor of the second circuit board is connected to the first circuit board via the socket; and a small form factor cage mounted to the second carrier board. An optical small form factor pluggable may be connected in a port of the small form factor cage whereby the optical small form factor pluggable is effectively coupled to the first conductor. As a result of the coupling to the motherboard provided by the orientation of the carrier board, the maximum density of connectors readily accessible from the exterior of such networking equipment is increased relative to that of networking equipment that directly mounts the connector to the motherboard.

Reference herein to “one embodiment”, “another embodiment”, “an exemplary embodiment” and “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. Although various embodiments which incorporate the teachings of the present invention have been shown and described in detail herein, those skilled in the art can readily devise many other varied embodiments that still incorporate these teachings.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting, and wherein

FIG. 1 conceptually illustrates an exemplary embodiment of a system in accordance with the invention;

FIG. 2 conceptually illustrates a portion of an exemplary embodiment of a system in accordance with the invention and in which a first portion of the front panel is removed for clarity;

FIG. 3 conceptually illustrates a portion of an exemplary embodiment of a system in accordance with the invention and in which the motherboard is removed for clarity; and

FIG. 4 conceptually illustrates an exemplary embodiment of system in accordance with the invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Various example embodiments will now be described more fully with reference to the accompanying figures, it being noted that specific structural and functional details disclosed herein are merely representative for purposes of describing example embodiments. Various structures, systems and devices are schematically depicted in the drawings for purposes of explanation only and so as to not obscure the embodiments with details that are well known to those skilled in the art. Nevertheless, the attached drawings are included to describe and explain illustrative examples according to the principles of the present invention. Example embodiments may be embodied in many alternate forms and should not be construed as limited to only the embodiments set forth herein.

The words and phrases used herein should be understood and interpreted to have a meaning consistent with the understanding of those words and phrases by those skilled in the relevant art. Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning, such a special definition will be expressly set forth in the specification in a definitional manner that directly and unequivocally provides the special definition for the term or phrase.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. As used herein, the term “and” is used in both the conjunctive and disjunctive sense and includes any and all combinations of one or more of the associated listed items. The singular forms “a”, “an” and “the” are intended to include the plural forms as well, unless the context clearly indicates otherwise. It will be further understood that the terms “comprises”, “comprising,”, “includes” and “including”, when used herein, specify the presence of stated features, integers, steps, operations, elements, and/or components, but do not preclude the presence or addition of one or more other features, integers, steps, operations, elements, components, and/or groups thereof.

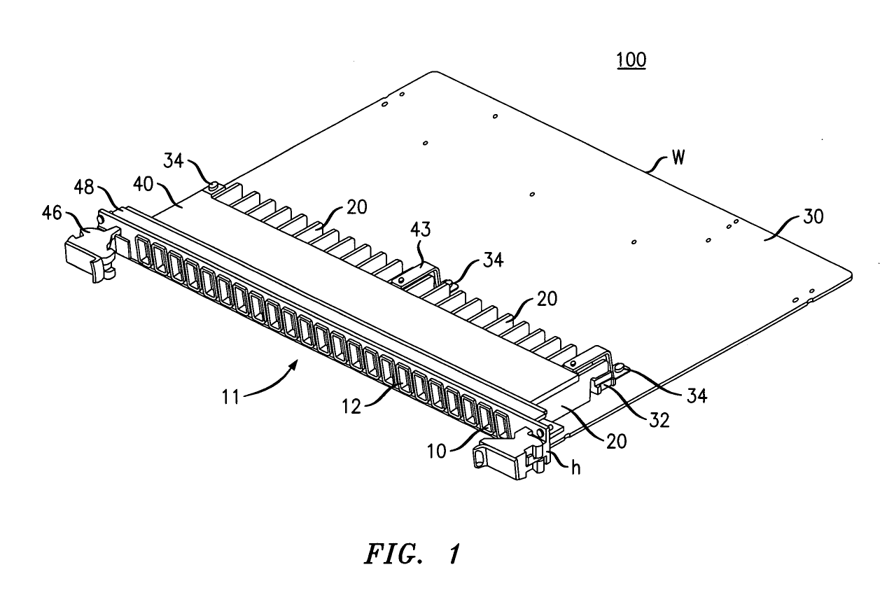

FIG. 1 conceptually illustrates an exemplary embodiment of a system in accordance with the invention. The networking equipment module 100 includes a cage 10, a carrier board 20 and a motherboard (i.e., main circuit board) 30. The cage, which is used for a connecting a pluggable component (e.g., a transceiver) and shielding electromagnetic interference (EMI), is mounted to the carrier board. The carrier board is connected to and oriented approximately normal to the motherboard. The motherboard includes a socket 32. The carrier board may be connected to the mother board via the socket. The carrier board also may be connected to the motherboard by other means such as for example, mechanical fixing of the carrier board to the motherboard.

Additional electrical components (not shown) are connected to the motherboard to provide at least portions of the functionality associated with the network equipment. An individual networking equipment module may be a switch, router, media converter, blade server, add/drop multiplexer, etc., or similar device. The module may further include a front panel 40 with the front panel connected to anchor points 34 on the motherboard.

An array 11 of connector ports 12 provided by the arrangement of cages and carrier boards is positioned across an edge of the motherboard. For example, twenty-four SFF connectors 10.7 mm×15.5 mm placed on carrier boards can be arrayed at a 13 mm pitch across an edge of a module measuring 22 mm×approximately 372 mm, while leaving space for a module ejector on either side of the module. Connector ports are readily accessible from the exterior of the module via the front panel. The provided arrangement orients the connector ports at a substantially right angle to direct mounting of cages to the motherboard so as to permit placement into the same area of a greater number of connector ports at a decreased pitch. As a result, embodiments of network equipment modules according to the principles of the invention enable increased bandwidth.

The module may be designed for installation in a rack system (not shown). In a conventional rack system, a plurality of network equipment modules is arrayed on a rack, each of the modules occupying a predetermined space on a shelf of the rack. The shelves in a rack typically lie in a horizontal plane, with the width of a shelf greater than the distance between adjacent shelves. The module can be deployed horizontal or vertical depending on the shelf orientation. As illustrated in FIG. 1, the module has a width w and a height h, which enables the module to be installed on a shelf of a rack system. The constituent parts of a module may be sized so as to provide modules of varying dimension, which may be installed into one of a plurality of racks of varying dimension. Further, should it be desirable, a plurality of connector ports may be provided on the carrier board, each connector port providing separate coupling to the motherboard. In another embodiment, cages may be mounted and connector ports provided on carrier boards of varying length. The varying length carrier boards with the connector ports may then be similarly stacked in height h and connected to the motherboard. As a result of this arrangement, the number of connectors readily accessible from the exterior of the module is not limited by the area of the motherboard directly adjacent and accessible to the faceplate and upon which connectors may be directly mounted.

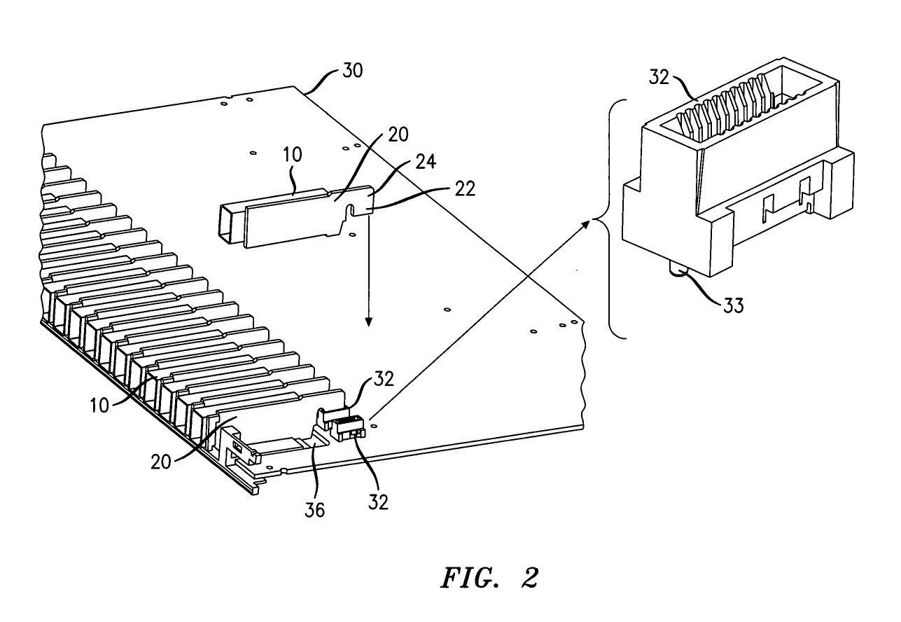

FIG. 2 conceptually illustrates a portion of an exemplary embodiment of a system in accordance with the invention and in which an upper portion of the front panel is removed for clarity. The cage 10 is mounted to the carrier board 20. The motherboard 30 includes a socket 32 for receiving the carrier board. The socket may include a locking pin 33, which provide additional mechanical strength for the connection of the socket to the motherboard. In another embodiment, the socket may include locking clips to assist in connection to the motherboard.

The carrier board includes at least one first conductor 22 which may be coupled to the motherboard via the socket. The first conductor may be disposed on a surface of the carrier board. A lateral extension 24 may extend from a first portion of a first side of the carrier board, with the first conductor disposed on the lateral extension. In another embodiment, cages may be mounted and connector ports provided on carrier boards of varying length having differently sized lateral extension for connected to sockets. The varying length carrier boards with the connector ports may then be similarly stacked in height h and connected to a motherboard, having a 2×N array of sockets.

In one embodiment, the socket is a high speed Micro Edge SMT socket Samtec HSEC8 Series. Other sockets may be utilized such as, edge line complaint pin connectors by, for example Molex. The carrier board may also be alternatively connected to the motherboard. For example, the carrier board may be directed connected to the motherboard via a land or pin, or a lead may run from conductor of the carrier board to the motherboard.

The motherboard may include a cutout 36. Portions of the cage and/or carrier board may be positioned in the cutout. The cage may be a small form factor cage or physically compact connector cage. The arrangement of the carrier board and small form factor cage provides a connector port, the interior of the connector port including a first connection point for a first conductor, the first conductor associated with a second connection point on the carrier board and located outside the connector port. For example, the small form factor cage may define a connector port which is mounted to the carrier board. In another embodiment, the cage has four-sides such that when mounted to a carrier board having one-side, a connector port is defined. The first connector point may be provided on a surface of the cage or the carrier board.

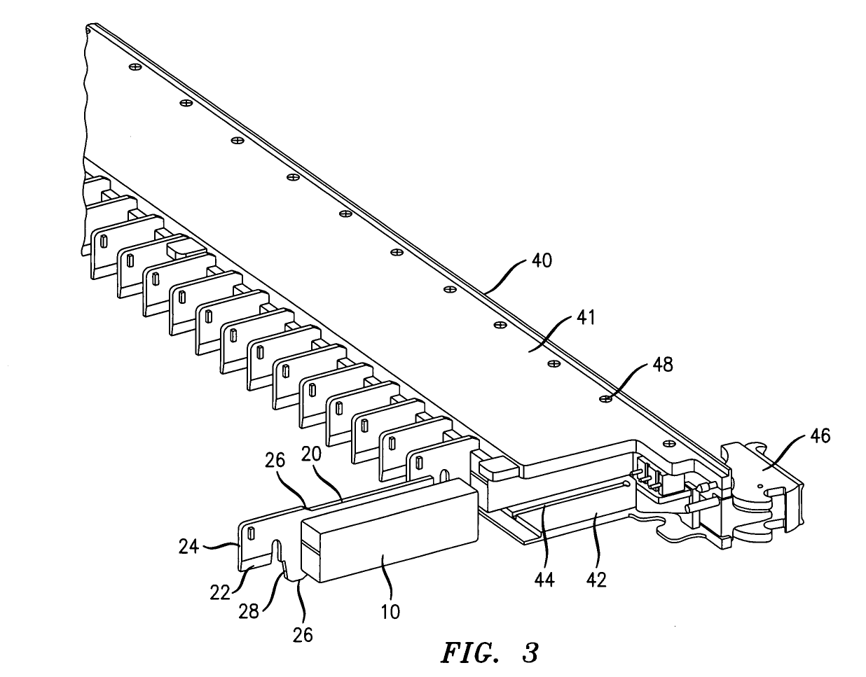

FIG. 3 conceptually illustrates a portion of an exemplary embodiment of a system in accordance with the invention and in which the motherboard is removed for clarity. Front panel 40 may include an upper portion 41 and a lower portion 42. The front panel may be attached to the motherboard (not shown) at one or more anchor points via panel arms 43 (illustrated in FIG. 1). Once attached to the motherboard, the front panel inhibits movement of the carrier board and cage relative to the motherboard.

Either or both of the upper and lower portions of the front panel may include a carrier guide 44 for a carrier board. The carrier guide receives a corresponding edge 26 of the carrier board 20 so as to limit movement of the carrier board in an undesired direction relative to the front panel, thus minimizing movement relative to a undesirable direction relative to the motherboard which minimizes stress on the carrier board and socket connection to the motherboard. The carrier guides also assist in alignment of the carrier board with the socket of the motherboard, providing a card cage design approach.

The front panel may also be made of a thermal conductive material. For example, the front panel may be made of aluminum. When attached of the motherboard, the front panel thus assists in thermal management, such as removing heat by conduction and convection. The system may also include an ejector 46 attached to the front panel. The ejector is used to releasably secure the module to a shelf. The front panel may also include a gasket 48 for Electromagnetic Interference (EMI) isolation when the module is deployed in a rack.

First conductor 22 utilized for connection with the socket lies on lateral extension 24. The lateral extension extends from a first portion of a first side 28 of the carrier board 20. A first portion of the side 28 from which the lateral extension extends interfaces with the motherboard to stop movement of the carrier board.

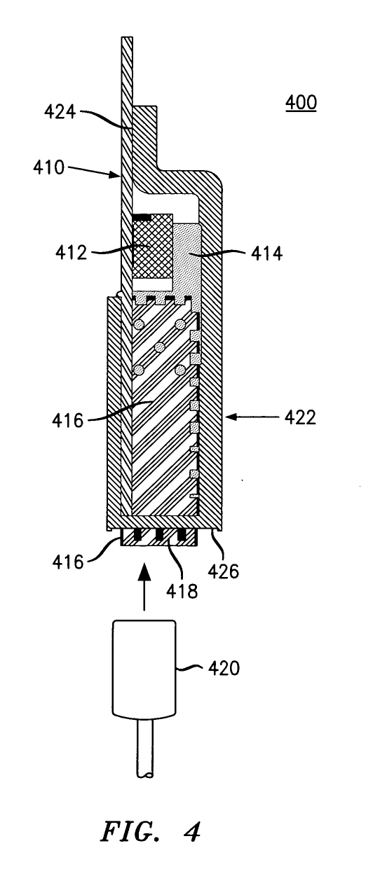

FIG. 4 conceptually illustrates an exemplary embodiment of system in accordance with the invention. The exemplary networking equipment illustrated 400 includes a first circuit board 410 including a socket 412 mounted thereon, a second circuit board 414 oriented normal to and coupled to the first circuit board, and a small form factor cage 416 mounted to the second carrier board. For example, to couple the first circuit board to the second circuit board, a first conductor on the second circuit board may be connected via the socket to the first circuit board.

A connector port 418 is provided for the connection of an optical small form factor pluggable (SFP) 420. As a result of the orientation of cage mounted to the carrier board, an increased number of connectors that are readily accessible from the exterior of such networking equipment may be provided as compared to networking equipment with cages mounted directly to a module motherboard. Likewise, an increased number of SFPs can be connected to networking equipment modules so constructed.

A panel 422 may be attached to the first circuit board at an anchor point 424. The panel prevents movement of the second circuit board and small form factor cage once the second circuit board is connected to the first circuit board via the socket. The panel may also include a faceplate 426 having an opening into which is fit the small form factor cage. The panel integrates a card cage design approach with the second circuit board. The panel ensures SFP orientation normal to first circuit board with a card guide approach integrated into the panel. A module so constructed enables SFPs to be secured and properly positioned while providing a thermal conduit for extraction of heat generated by SFPs and allowing proper channeled airflow to the SFPs to remove the conducted heat.

The bandwidth of the module is driven by the number of optical interfaces that can fit on and are accessible to the faceplate. Thus, an increased number of connectors accessible on the module enable increased bandwidth to be provided by the module. Increasing the bandwidth of a module provides a competitive advantage.

Once connected in the port of the small form factor cage, the SFP is effectively coupled to the first conductor of the second circuit board. SFPs may be used to provide the module with additional functionality that cannot be implemented on the first circuit board due to size constraints or to provide functionality that is easily changeable/upgradable. In the network equipment module provided, the SFP is oriented normal to the first circuit board, which permits increased SFP density in the limited accessible space available on the module, which may be positioned in a rack. For example, in one embodiment, with the orientation of SFPs normal to the first circuit board, the optical SFPs may be placed at 13 mm pitch instead of a 20 mm pitch. The small form factor pluggable may be an optical small form factor pluggable that provides transceiver, receiver or transmitter functionality.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified and all such variations are considered within the scope and spirit of the invention.

What is claimed is:

1. A system comprising:
a cage;
a carrier board, the cage mounted to the carrier board; and
a motherboard, the carrier board connected to and oriented approximately normal to the motherboard.

2. The system of claim 1,
wherein the carrier board includes at least one first conductor disposed on a surface of the carrier board; and
wherein the motherboard includes a socket for receiving the at least one first conductor of the carrier board.

3. The system of claim 1 further comprising:
a front panel including a carrier guide, the carrier guide for receiving an edge of the carrier board and preventing movement of the carrier board.

4. The system of claim 3 wherein the front panel is made of a thermal conductive material and is connected to an anchor point on the motherboard.

5. The system of claim 3 further comprising:
an ejector connected to the front panel.

6. The system of claim 1 wherein the carrier board has a first side, wherein the carrier board includes a lateral extension on a first portion of the first side, and wherein at least one first conductor is disposed on the lateral extension.

7. The system of claim 1 wherein the motherboard includes a cutout, portions of the cage lying in the cutout.

8. The system of claim 1 wherein the motherboard includes a cutout, portions of the carrier board lying in the cutout.

9. The system of claim 1 further comprising
a small form factor pluggable, the small form factor pluggable connected in the cage.

10. The system of claim 9 wherein the small form factor pluggable is an optical small form factor pluggable.

11. The system of claim 9 wherein the small form factor pluggable is a transceiver, receiver or transmitter.

12. A system comprising:
a small form factor cage;
a carrier board to which the small form factor cage is mounted, wherein a connector port is defined by the small form factor cage and the carrier board, the interior of the connector port including a first connection point for a first conductor, the first conductor running to a second connection point, the second connection point on the carrier board and outside the connector port; and
a motherboard, the carrier board oriented normal to a motherboard, the motherboard including a socket for receiving the second connection point.

13. The system of claim 12 wherein the carrier board has a first edge, the carrier board including a lateral extension on a first portion of the first edge, and wherein the second connection point is located on the lateral extension.

14. The system of claim 12 wherein the motherboard includes a cutout proximate the socket, portions of the small form factor cage and the carrier board lying in the cutout.

15. The system of claim 12 wherein the motherboard includes an anchor point, the system further comprising:
a thermal conductive front panel including a carrier guide for receiving the carrier board, the thermal conductive front panel connected to the motherboard at the anchor point.

16. The system of claim 15 further comprising:
an ejector connected to the thermal conductive front panel.

17. The system of claim 12 further comprising
an optical small form factor pluggable connected to the small form factor cage.

18. The system of claim 12 wherein the small form factor pluggable is a transceiver, receiver or transmitter.

19. A networking equipment comprising:
a first circuit board including a socket mounted thereon;
a second circuit board oriented approximately normal to a first circuit board, a first conductor of the second circuit board connected to the first circuit board via the socket; and
a small form factor cage mounted to the second carrier board.

20. The networking equipment of claim 19 further comprising:
an optical small form factor pluggable connected in a port of the small form factor cage whereby the optical small form factor pluggable is effectively coupled to the first conductor.
